(19) United States
(12) Patent Application Publication
(10) Pub. No.: US 2023/0383549 A1
(43) Pub. Date: Nov. 30, 2023

(54) Applicator Devices and Related Methods

(71) Applicant: Ultimate Hawk Systems LLC, Riverton, UT (US)

(72) Inventor: John L. Stubbs, Saratoga Springs, UT (US)

(73) Assignee: Ultimate Hawk Systems LLC, Riverton, UT (US)

(21) Appl. No.: 18/324,499

(22) Filed: May 26, 2023

Related U.S. Application Data
(60) Provisional application No. 63/365,479, filed on May 27, 2022.

(51) Int. Cl. E04F 21/08; B05C 17/12

(52) U.S. Cl. CPC E04F 21/08; B05C 17/12

(57) ABSTRACT

An applicator device may include a back panel, and may further include one of: a pole attached to the back panel; and a coupler coupled with the back panel and configured for receiving a pole. The applicator device may include an applicator panel having four sides each of which at least partially defines a rectangular perimeter, the applicator panel comprising a plurality of openings. The applicator device may include at least one spacer coupled between the applicator panel and the back panel, the at least one spacer facilitating a gap between the applicator panel and the back panel, wherein the applicator panel comprises a flat top surface and is configured for applying a layer of wet drywall compound to one of a wall and a ceiling. In implementations multiple spacers are included, which are hollow, and which facilitate coupling of the back and applicator panels using threaded couples passing therethrough.

### CROSS REFERENCE TO RELATED APPLICATIONS

This document claims the benefit of the filing date of U.S. Provisional Patent Application No. 63/365,479, entitled “Applicator Devices and Related Methods,” naming as first inventor John L. Stubbs, which was filed on May 27, 2022, the disclosure of which is hereby incorporated entirely herein by reference.

### BACKGROUND

### 1. Technical Field

Aspects of this document relate generally to applicator devices and related methods used to apply drywall compound (drywall mud) to surfaces.

### 2. Background Art

Drywall compound, otherwise known as drywall mud, can be applied to ceilings and walls of buildings during their construction or repair. For example, the walls and ceilings of buildings are often formed by securing drywall panels (sometimes called wallboard) to wooden or metal frame elements, such as with nails, screws, or staples. To ensure a flat and aesthetically appealing surface, drywall compound is often applied at the gaps between adjacent drywall panels (or otherwise where drywall panels meet) and/or at the locations where screws, nails, staples, or the like were driven through the drywall panels. Once the drywall compound is applied, it can be smoothed and extra compound removed, then allowed to dry. It can then be sanded to further ensure a flat and smooth surface. Various tools are used to apply drywall compound and/or plaster and/or spackling and/or to smooth and/or texture it, including hawks (such as for holding drywall compound while applying it using a separate applicator), texture sprayers, darbies (such as for example applying an undercoat layer when working with stucco or plaster), brushes and texture brushes, flat boxes (for applying even layers of drywall compound), knives, taping knives, joint knives, knock-down knives (to give wall and ceiling textures a flattened appearance), skimming blades (such as for example for smoothing out fresh drywall compound and/or for bedding and wiping down applied drywall tape), sanders, drywall sanders, sandpaper, and sanding sponges.

### SUMMARY

In some aspects, the techniques described herein relate to an applicator device, including: a back panel; one of: a pole attached to the back panel; and a coupler coupled with the back panel and configured for receiving a pole; and an applicator panel having four sides each of which at least partially defines a rectangular perimeter, the applicator panel including a plurality of openings; and at least one spacer coupled between the applicator panel and the back panel, the at least one spacer facilitating a gap between the applicator panel and the back panel; wherein the applicator panel includes a flat top surface and is configured for applying a layer of wet drywall compound to one of a wall and a ceiling.

In some aspects, the techniques described herein relate to an applicator device, wherein the back panel has four sides each of which at least partially defines a rectangular perimeter.

In some aspects, the techniques described herein relate to an applicator device, wherein the rectangular perimeter at least partially defined by the back panel is substantially equivalent in shape and size to the rectangular perimeter at least partially defined by the applicator panel.

In some aspects, the techniques described herein relate to an applicator device, wherein some of the plurality of openings are not fully circumscribed by the applicator panel.

In some aspects, the techniques described herein relate to an applicator device, wherein some of the plurality of openings are fully circumscribed by the applicator panel.

In some aspects, the techniques described herein relate to an applicator device, wherein the at least one spacer includes a plurality of spacers, each of the plurality of spacers including a substantially identical height so that the gap between the applicator panel and the back panel is substantially equal proximate each spacer.

In some aspects, the techniques described herein relate to an applicator device, wherein the at least one spacer is hollow, and wherein the applicator panel is coupled with the back panel using a fastener which passes through the at least one spacer.

In some aspects, the techniques described herein relate to an applicator device, wherein the fastener which passes through the at least one spacer includes one of a bolt and a screw.

In some aspects, the techniques describe herein relate to an applicator device, wherein the applicator panel is substantially black to provide visual contrast with the wet drywall compound.

In some aspects, the techniques described herein relate to an applicator device, wherein the four sides of the applicator panel at least partially define a square perimeter.

In some aspects, the techniques described herein relate to an applicator device, wherein the applicator device includes the coupler coupled with the back panel, and wherein the coupler is a threaded coupler.

In some aspects, the techniques described herein relate to an applicator device, wherein the back panel includes a plurality of openings, and wherein the threaded coupler is coupled with the back panel using fasteners that pass through the openings.

In some aspects, the techniques described herein relate to an applicator device, wherein the fasteners that pass through the openings include threaded fasteners.

In some aspects, the techniques described herein relate to an applicator device, wherein the applicator device includes the pole, and wherein the pole is a threaded pole configured for attaching to the threaded coupler.

In some aspects, the techniques described herein relate to an applicator device, wherein the back panel is formed of one of a metal and a polymer, and wherein the applicator panel is formed of one of a metal and a polymer.

In some aspects, the techniques described herein relate to an applicator device, including: a back panel; one of: a pole attached to the back panel; and a coupler coupled with the back panel and configured for receiving a pole; an applicator panel including a plurality of openings; and a plurality of spacers coupled between the applicator panel and the back panel, the spacers facilitating a gap between the applicator panel and the back panel; wherein at least one of the spacers is hollow, and wherein the applicator panel is coupled with the back panel using a threaded fastener which passes through the hollow spacer; and wherein the applicator panel includes a flat top surface and is configured for applying a layer of wet drywall compound to one of a wall and a ceiling.

In some aspects, the techniques described herein relate to an applicator device, wherein the applicator panel has four sides each of which at least partially defines a rectangular perimeter.

In some aspects, the techniques described herein relate to an applicator device, wherein each of the spacers is hollow, and wherein the applicator panel is coupled with the back panel using a plurality of threaded fasteners passing through the spacers.

In some aspects, the techniques described herein relate to an applicator device, including: a back panel having four sides each of which at least partially defines a first rectangular perimeter; a threaded coupler coupled with the back panel and configured for receiving a threaded pole; an applicator panel having four sides each of which at least partially defines a second rectangular perimeter, the applicator panel including a plurality of openings; a plurality of spacers coupled between the applicator panel and the back panel, each of the spacers having a substantially identical height, the spacers facilitating a gap between the applicator panel and the back panel, wherein each of the spacers is hollow; and a plurality of threaded fasteners, each threaded fastener coupling the applicator panel with the back panel through one of the spacers; wherein the applicator panel includes a flat top surface and is configured for applying a layer of wet drywall compound, in a repeating pattern, to one of a wall and a ceiling.

In some aspects, the techniques described herein relate to an applicator device, wherein the first rectangular perimeter is substantially equivalent in shape and size to the second rectangular perimeter.

In some aspects, the techniques described herein relate to an applicator device, wherein some of the plurality of openings are not fully circumscribed by the applicator panel, wherein the first rectangular perimeter includes a square, and wherein the second rectangular perimeter includes a square.

General details of the above-described implementations, and other implementations, are given below in the DESCRIPTION, the DRAWINGS, the CLAIMS and the ABSTRACT.

### BRIEF DESCRIPTION OF THE DRAWINGS

Implementations will be discussed hereafter using reference to the included drawings, briefly described below, wherein like designations refer to like elements. The drawings are not necessarily drawn to scale.

FIG. 1 is a top, front, perspective view of elements of the applicator device of FIG. 4;

FIG. 2 is a right side, top, perspective view of the elements of FIG. 1;

FIG. 3 is a top, rear, perspective view of the elements of FIG. 1;

FIG. 4 is a bottom, left side, perspective view of an applicator device being dipped in drywall compound;

FIG. 5 is a bottom, front, right side view of the applicator device of FIG. 4 being used to apply drywall compound to a ceiling;

FIG. 6 is a bottom, rear, left side view of the applicator device of FIG. 4 being used to apply drywall compound to a ceiling;

FIG. 7 is a bottom, rear, left side view of the applicator device of FIG. 4 being used to apply drywall compound to a ceiling;

FIG. 8 is an image of a ceiling and walls after the applicator device of FIG. 4 has been used to fully apply a pattern to the ceiling (but before the ceiling has been painted); and

FIG. 9 is a close-up image of the ceiling of FIG. 8 after the ceiling has been painted and lighting has been installed.

### DESCRIPTION

Implementations/embodiments disclosed herein (including those not expressly discussed in detail) are not limited to the particular components or procedures described herein. Additional or alternative components, assembly procedures, and/or methods of use consistent with the intended applicator devices and related methods may be utilized in any implementation. This may include any materials, components, sub-components, methods, sub-methods, steps, and so forth.

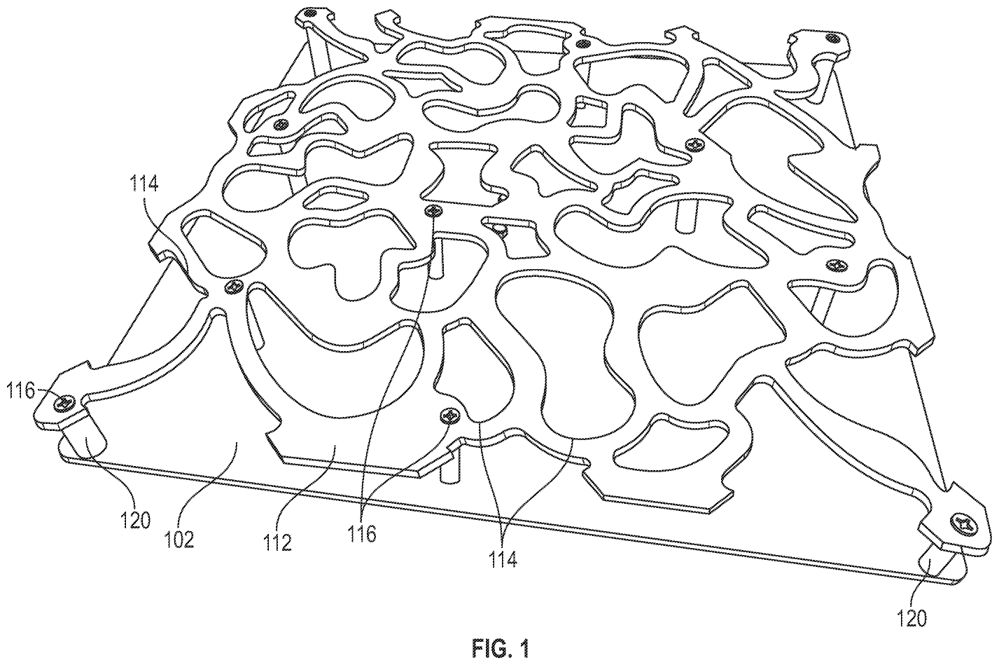

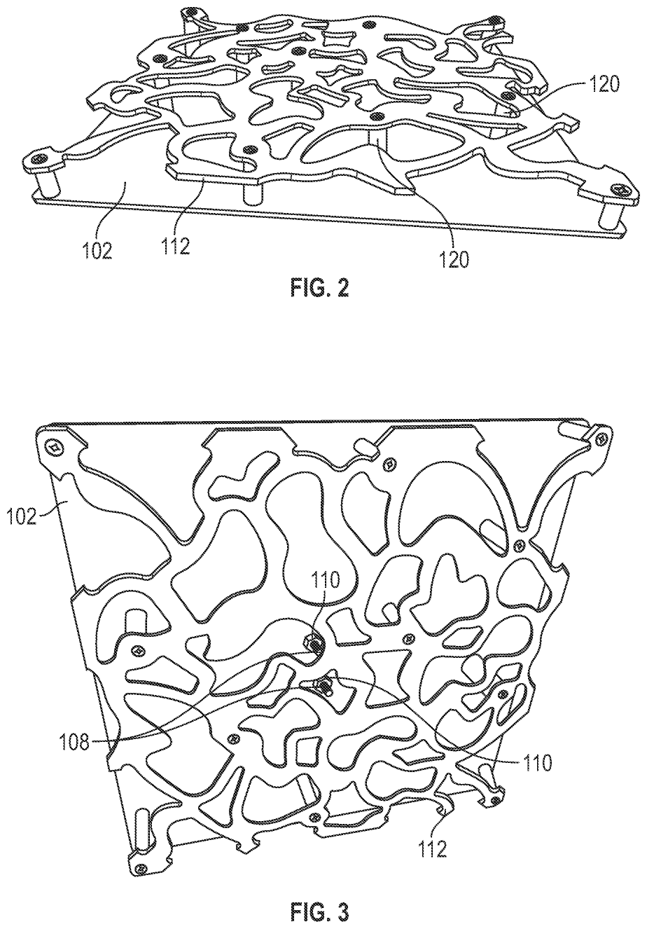

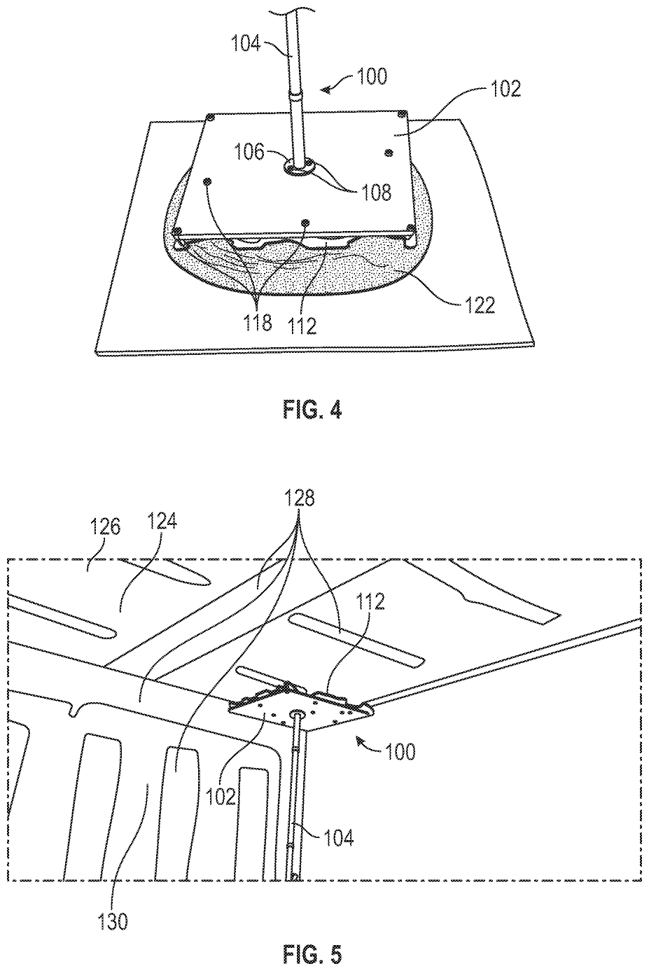

With regards to the drawings, it is pointed out that, for simplicity and for ease of viewing the elements shown, some elements are excluded in some of the views (for example in FIG. 4 only seven nuts 118 are shown though in reality there are eleven). Additionally, some elements shown from different angles are intended to be the same element though there are slight variations in their representations. For example, FIG. 1 shows a top, front, perspective view of elements of the applicator device of FIG. 4, and FIG. 2 shows a right side, top, perspective view of the same elements but there are some minor variations in the illustrated openings 114 of the applicator panel 112. Nevertheless, the views are intended to represent the same applicator panel 112 viewed from different angles. These are only examples, and other instances of elements that are excluded in some views or figures, or that are drawn not exactly similar from figure to figure, exist in the drawings.

Referring now to FIGS. 1-7, an applicator device (applicator) 100 and several of its components are shown. The applicator device 100 includes a back panel 102. In the implementations shown in the drawings the back panel is formed from a one-fourth inch thick high density polyethylene (HDPE) sheet, cut to a size of twenty-two inches by twenty-two inches (or otherwise initially formed to that size). In implementations the HDPE sheet has gone through an additional annealing process to reduce stress (such as to ensure a flatter configuration and/or less likelihood of any bowing over time), though in implementations this is not done.

The HDPE is black, which helps the drywall compound to be easily seen on it, there being a high contrast between the drywall compound and the HDPE. In other implementations other rigid polymers could be used such as polyvinyl chloride (PVC), polypropylene (PP), and so forth. Metallic materials could be used, but the use of polymers helps the back panel to be lightweight (along with the applicator panel, discussed hereafter), which is useful to reduce fatigue from a user while using the applicator device. In implementations the back panel could be formed of a composite material.

The back panel has openings (which may be bolt holes) for threaded fasteners, such as by non-limiting example bolts 108 and 116. In the drawings these bolt holes are not visible because of the bolts and corresponding nuts 110/118. A threaded coupler 106 is attached to the back panel using bolts 108 and corresponding nuts 110 (the bolt and nut positions/locations could be reversed, if desired). In the drawings the threaded coupler is formed of metal, such as a steel or aluminum, though in other implementations it could be formed of a rigid polymer or composite material. The threaded coupler includes female threads (not shown in the drawings) for receiving male threads (not shown in the drawings) of a pole 104. The pole in the drawings is accordingly a threaded pole and is formed of a metal, such as a steel or aluminum, though in other implementations it could be formed of a rigid polymer, wood or a composite material (though the male threads could be formed of metal and coupled with a portion of the pole even if the pole itself is not metal, or the threads could be integrally formed with a non-metal pole material). The pole is seen to be orthogonal to the plane of the back panel, and allows a user to directly press the applicator device upwards when applying drywall compound to a ceiling (as seen in FIG. 5). In implementations the female/male thread configuration could be reversed, or the attachment mechanism between the pole and back panel could be something other than threads entirely. In some manner, however, the pole will be coupled with the back panel (either permanently or removably) in a fixed or static, non-moving configuration, either directly or through some other component, so that the applicator panel (described later) may be held steady while drywall compound is lightly applied to a ceiling. The bolts 108 and nuts 110 in the drawings are formed of a metal, such as steel, though they could be formed of any other metal or even a rigid polymer or other rigid material, in implementations. Additionally, attachment mechanisms other than bolts/nuts could be used, and in some implementations one or more or all components of the applicator device could be integrally formed such as using three-dimensional (3D) printing or another fabrication technique. In implementations the pole may be a common painter's pole.

An applicator panel 112 is coupled with the back panel but is spaced therefrom using spacers 120. The applicator panel may be formed of any materials disclosed above for the back panel. In the drawings the applicator panel is made of the same material and color as the back panel, and having the same thickness and other dimensions, except that the applicator panel has been laser cut to form openings 114 therein to form a design. Other cutting or material removal techniques could be used to form the openings, or the applicator panel could be integrally formed with the openings therein, such as using a mold which inherently forms the openings during molding. Additionally, the back panel and applicator panel could have thicknesses other than one-fourth inch, such as between one-eighth inch and one-half inch, or any other size, though a one-fourth inch thickness creates sufficient rigidity for drywall compound application and also keeps material costs low. Additionally, the panels could have sizes other than twenty-two inches by twenty-two inches, and could have a shape other than a square (such as a rectangle or circle or any other regular or irregular shape), though the twenty-two inch by twenty-two inch size, and the square shape, is a useful to keep the applicator device lightweight and also apply drywall compound in a step-wise approach without wasting material or time and without overlapping drywall compound (as can be envisioned from FIGS. 5-7, in which the user applies the drywall compound one square at a time without requiring overlap of any applications—though overlapping is also possible if the user desires to overlap applications). Colors other than black could be used for the panels, but dark colors are useful since drywall compound is a light color—the contrast allowing the user to more easily see how much drywall compound is on the panels for application and/or for cleaning later). Any type of design could be formed using openings 114, and there may be any number of openings—the design shown in the drawings is only one example. The design could be an abstract design, as in the drawings, or it could form one or more identifiable images such as grass, a mountain landscape, flower(s), tree(s), animal(s), or anything else.

The applicator panel includes bolt holes for receiving bolts 116, though the bolt holes are not visible in the drawings. Bolts 116 are passed through the bolt holes of the applicator panel and through hollow centers of spacers 120 and then through bolt holes of the back panel, and corresponding nuts 118 are secured to the bolts 116, to secure the back panel and applicator panel in fixed positions relative to one another and spaced apart using the spacers. The spacers in the drawings are formed of one inch long hollow copper tubes or copper bushings (for example cut from a longer tube or otherwise formed originally or later cut/sized to the one inch size), though in other implementations they could be formed of any other metal, or even a rigid polymer or composite. The spacers help to create a space between the panels. This allows excess drywall compound to drip down to the back panel so as to not negatively affect the design applied to a ceiling. The back panel helps prevent excess drywall compound which falls through the openings 114 from falling onto the user or onto the floor. The positions/locations of bolts 116 and nuts 118 could be reversed. Additionally, anything other than bolts/nuts could be used to secure the panels in the spaced position. For example in some implementations the spacers and panels could be integrally formed without requiring bolts and nuts at all. Other configurations are possible. In implementations the space between the panels makes it easier to clean the device after use. The space between panels is one inch in the drawings, but in other implementations it could be any other size such as between one-half inch and two inches, or any other desired size. The size of one inch allows sufficient space for a decent amount of excess drywall compound to fall between the panels and onto the back panel and also sufficient space to easily clean the applicator device after use by removing all drywall compound. Screws or friction fit elements or other coupling mechanisms could be used instead of any of the bolts/nuts described herein, in implementations.

FIGS. 4-7 representatively illustrate a user using the applicator device. It is pointed out that the ceiling 124 and walls 130 are already somewhat prepared ahead of time. For example, the ceiling and walls may be formed of drywall 126 and drywall tape may be used to cover or form joints between drywall panels and/or drywall compound 128 may be used at the junctures between drywall panels (or may be used to cover areas where the drywall panels were stapled, screwed, or nailed to wood or metal frame elements), as seen in the drawings. The ceiling and walls of FIGS. 4-7 have not yet been painted, however. The methods of FIGS. 4-7, in the drawings, accordingly, occur after drywall panels have been used to create ceilings and walls and after junctures between drywall panels (and screwed/stapled/nailed locations of drywall panels) have been covered or filled in using drywall tape and/or drywall compound (such as during the initial construction of a building or room). In implementations the ceiling may have two coats of drywall compound applied at the drywall panel joints (and/or at the screwed/stapled/nailed locations) and these areas may be sanded to get the ceiling smooth before the design/texture is applied using the applicator device 100. This is just one example, and fewer or more coats of drywall compound could be applied at the drywall panel joints and/or at the screwed/stapled/nailed locations, and/or more or less or no sanding done of those areas, before applying the design. In some implementations the methods of FIGS. 4-7 could be done to apply a design or texture to a ceiling or wall that has already been finished and painted (and thereafter the texture/design can be smoothed and painted over, as desired).

In FIG. 4 the user has prepared a sufficient amount of drywall compound 122 on a surface and dips the applicator panel onto the drywall compound. In implementations this entails the user dipping the panel once, then rotating it ninety degrees and dipping it again, then rotating it ninety degrees in the same rotation direction and dipping it again. Other options are possible, but this method allows the user to apply a sufficient amount of drywall compound to the surface of the applicator panel and to ensure that no portions of the design formed by the applicator panel have been missed.

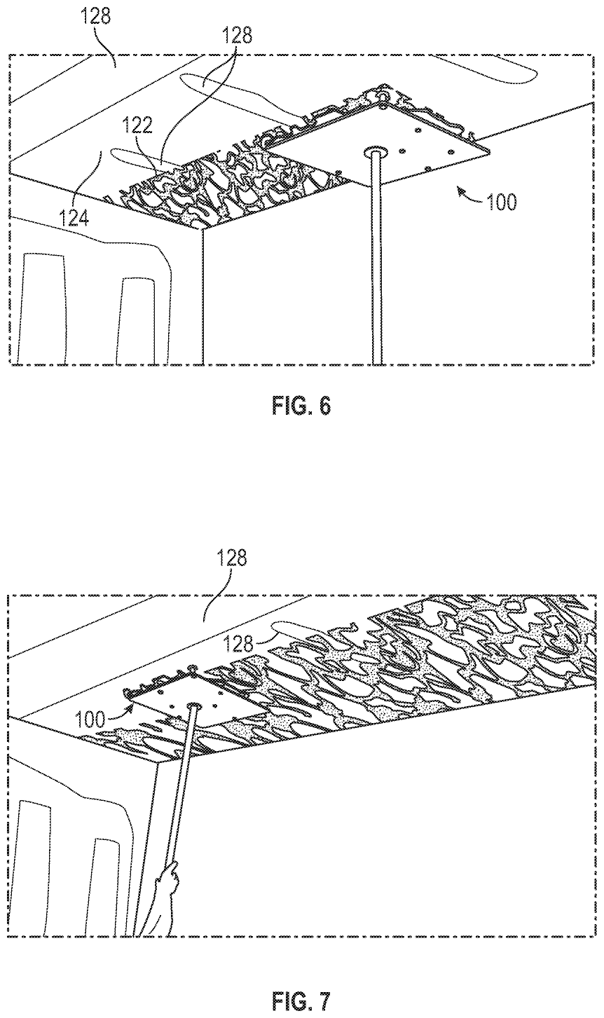

As shown in FIGS. 5-6, the user then holds the applicator device in a completely upright position so that the applicator panel is parallel with the ceiling and pushes the applicator device upwards to make contact with the ceiling. The user then moves one square over (twenty-two inches over, in this example) and makes contact again, then moves one square over and makes contact again. In implementations the user can, in this manner, have three applications per dipping procedure. The user then dips the applicator panel again and applies three more applications to the ceiling, and so on, as indicated by FIG. 7, continuing until the entire ceiling (or any desired portion thereof) is covered with the design. The upward pushing of the applicator device to apply the drywall compound pattern to the ceiling may be simply a light, flat touch—just lightly setting the drywall compound on the ceiling, so as not to use too much drywall compound, or to avoid spreading out the drywall compound by too much pressure or flattening it too much by too much pressure, or having the drywall compound spill below to the back panel too much, or so forth.

In other implementations there may be more or fewer than three applications per dip, depending on the consistency of the drywall compound and on the desired texture thickness for the design. During dipping, the user may in implementations dip the applicator panel into the drywall compound about one-half inch, though in other implementations the user may dip only one-fourth inch or less into the drywall compound each time, or just enough into the drywall compound to get the drywall compound on the face/surface of the applicator panel.

Although the user does not generally need to overlap each square (or other shape) of application, if it turns out the user has had one or more applications that did not apply much drywall compound, the user can simply make another application at that location (either trying to maintain the same position of the applicator panel so as to not change the overall design at that location, or not, as desired) to add more drywall compound at that location.

Once the user has finished applying the pattern or design in the manner shown in FIGS. 4-7 to the entire ceiling or entire desired area, and while the drywall compound is still pliable and wet, the user then does a smoothing or flattening procedure using a knife (such as a knockdown knife). In the drawings this flattening/smoothing procedure is not shown. The user does this flattening procedure over the entire ceiling, however, by drawing the knife across the entire ceiling in a row-by-row fashion, for example. The flattening/smoothing procedure does not fully flatten the patterned design, but flattens and smooths it so that the patterned design is about one-sixteenth inch thick and of relatively uniform thickness over the entire ceiling, though there may of course be some variation. The knife used for the ceiling in the drawings was a twenty-four inch wide steel blade knockdown knife. Other options are possible, such as an eighteen inch curved blue steel blade knockdown knife sold under the trade name WAL-BOARD. These are just examples, and the knockdown knife may, in implementations, be attached to the end of a long painter's pole to make the smoothing/flattening process easier to do from the ground, or the knockdown knife may have a shorter handle and the user may ascend a ladder to be closer to the ceiling such as to have greater precision or control. In implementations the knockdown knife may be somewhat pliable, such as formed of a thin metal or of a flexible polymer for the knife portion, as desired, depending on the amount of pressure desired for the smoothing/flattening process.

In implementations the smoothing/flattening procedure needs to be done relatively quickly after the pattern is initially applied, such as within several minutes (in some implementations within fifteen minutes), so that the drywall compound does not harden. If the drywall compound were to harden then it would form pointy projections downward from the ceiling and/or pieces would break off if smoothing/flattening were thereafter attempted. In implementations where pointy projections are desired the user could simply not do a flattening/smoothing procedure. Where pointy projections are not desired, a smoothing flattening procedures is done.

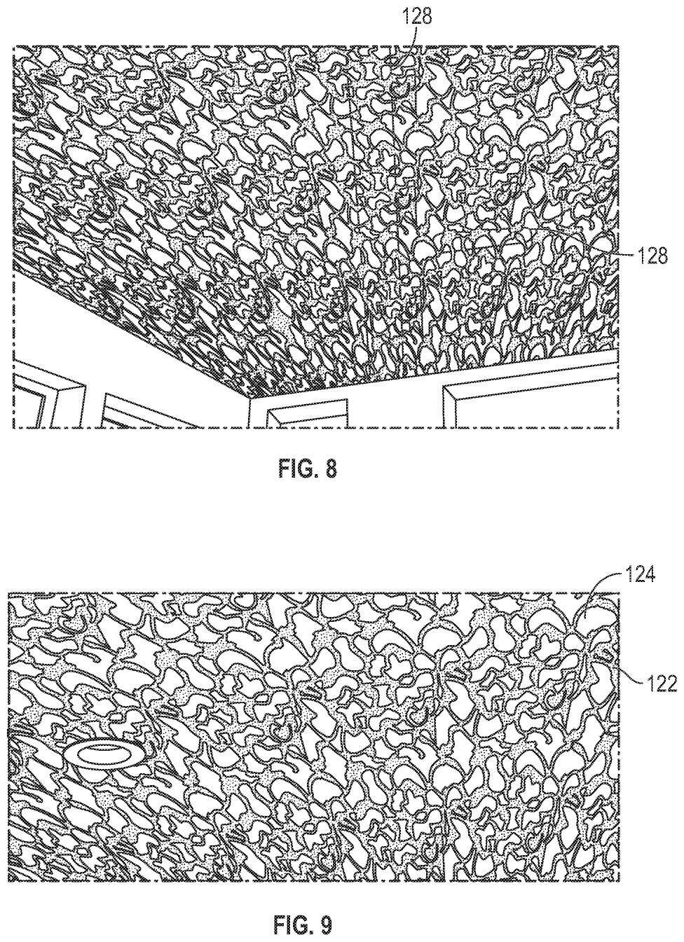

In implementations the drywall compound applied to the ceiling by the applicator device is the last drywall compound applied to the ceiling, and after the smoothing/flattening procedure the drywall compound is left to dry for about a day or at least for several hours. Thereafter, a light sanding (such as using a light sanding pole) may be done, then the ceiling may be painted. FIG. 8 shows the ceiling after the smoothing/flattening process has been completed but before painting (therefore some of the prior drywall compound 128 areas, applied before the design was applied, are still visible). FIG. 9 shows the ceiling after the light sanding and painting of the ceiling have been done, so the prior drywall compound 128 areas are painted over and not generally visible anymore. In FIG. 9 the ceiling is accordingly finished with the applied texture visible after the ceiling has been painted.

The devices and methods disclosed herein may be used to apply texture to ceilings, or to walls or other surfaces, using any design formed into or formed by an applicator panel. In implementations the drywall compound 122 and drywall compound 128 are the same material, though in implementations they may be different materials and/or different consistencies as desired by the user, based on using different amounts of water or different products, or so forth. In implementations the material for the panels 102/112 comes in four foot by eight foot sheets and is cut into twenty-two inch by twenty-two inch squares and then some of these squares are laser cut (or otherwise cut or material is otherwise removed) to form the openings 114 and, accordingly, the design in the applicator panels.

If the ceiling has areas or items such as recessed lighting, or curvature, specially shaped applicator panels may have non-square shapes (such as having round cutouts of the size/shape of common recessed lighting to apply the design around the recessed lighting but not at the location of the recessed lighting), or curved surfaces to apply texture to curved ceilings/walls, or the user may otherwise use careful application techniques to go around areas where it is not desirable to apply the design or to apply the design to curved areas.

Although the applicator panels could have non-square or non-rectangular shapes, such shapes would be harder to apply the design to an entire ceiling or wall quickly and without overlapping. Square or rectangular shapes allow the design to be very quickly applied to the ceiling or wall, by not overlapping the applications and by it visually being very easy to quickly determine where to make each next application in sequence, and this helps to not only reduce the time applying the design but also ensures that the applied drywall compound does not dry too much before the described smoothing/flattening process is done using the knockdown knife (because faster application means less drying before the smoothing/flattening). Additionally, for aesthetic purposes it may be desirable to not overlap the applications. In implementations the knockdown knife is not pressed hard against the ceiling during the smoothing/flattening process but only a light pressure is used so that the applied design/texture is not flattened too much. Although the example in the drawings results in a thickness of about one-sixteenth inch, other thicknesses, greater or less than one-sixteenth inch, may be achieved as desired by the user by applying more or less drywall compound during application or by applying different pressures during the smoothing/flattening process with the knockdown knife.

As can be seen in the drawings, in implementations the applicator panel has four sides, each of which at least partially defines a rectangular (in the drawings, square) perimeter. The back panel also has four sides, each of which at least partially defines a rectangular (in the drawings, square) perimeter. In implementations these perimeters are substantially equal or are equal in size and/or shape. As used herein, substantially means having at least 90% identicality or similarity in size, shape, or other features as dictated by the context in which it is used. The applicator panel in the drawings at least partially defines a square perimeter because a square perimeter can be identified or defined which would contact each side of the applicator panel in at least one location (indeed, in the drawings, three of the sides of the applicator panel would contact such a perimeter in four locations and one of the sides would contact the perimeter in five locations). Further, each corner of the applicator panel has sides that would contact two corresponding square perimeter sides. For at least one or more of these reasons, and possibly for other reasons, it is accurate to say that the applicator panel (and, for similar reasons, the back panel) at least partially defines a rectangular, and indeed a square, perimeter.

The number of spacers may be modified for any applicator device. It is seen in the figures that the spacers facilitating a gap between the applicator panel and back panel, and that since the spacers are in some cases substantially similar in size (or having equal or substantially equal heights) the respective panels are accordingly parallel, so that the gap between the applicator panel and the back panel is substantially equal proximate each spacer.

The figures show that some of the openings 114 are fully circumscribed in the applicator panel (for example the bottommost marked openings 114 of FIG. 1 are both circumscribed therein), while others are not fully circumscribed (for example the left marked opening 114 is not fully circumscribed therein). Such configurations may allow for a repeating pattern which does not require the four sides of the applicator panel to fully define a rectangular perimeter (which, if present, would create a full rectangular perimeter around each stamped instance of applied drywall compound)—instead the repeated stamped instances of applied drywall compound may create a repeating pattern which has no rectangular perimeters therein, as seen for example in FIG. 9.

In FIG. 4 the flat top surface of the applicator panel contacts wet drywall compound, and in FIGS. 5-7 the flat top surface of the applicator panel is raised toward a ceiling to apply the wet drywall compound to the ceiling (using as much pressure as desired according to the desired application—light touching or more pressing as desired). The user could overlap layers, if desired between stamping instances, or could simply use stamping steps wherein each applied portion is next to, but not overlapping with, a prior applied portion.

The pattern on the ceiling in FIGS. 6-9 may not match the pattern of the applicator panel exactly, but this is because the drawings are simplified so that the various elements may more easily be seen. In practice, the panner on the ceiling or wall or other surface would match (or substantially or generally match) the pattern of the applicator panel—it would be a repeating pattern thereof (or an overlapping pattern if the user applies overlapping applications).

The applicator panel may form thick lines or thin lines, depending on the thickness of the material of the panel between the openings, as desired.

The bolt and nut configurations of the various drawings are not all exactly matching and may look different from figure to figure. For example in FIG. 1 bolts are passed downward through the back panel to mate with nuts which are not visible (only the bolt heads are visible), while in FIG. 3 the bolts are passed upward through the back panel so that the terminal ends of the bolts and the nuts are visible. A variety of configurations are possible for the threaded fasteners (which in some cases may include screws with no corresponding nuts), and those configurations shown in the drawings are only examples.

In places where the phrase “one of A and B” is used herein, including in the claims, wherein A and B are elements, the phrase shall have the meaning “A and/or B.” This shall be extrapolated to as many elements as are recited in this manner, for example the phrase “one of A, B, and C” shall mean “A, B, and/or C,” and so forth. To further clarify, the phrase “one of A, B, and C” would include implementations having: A only; B only; C only; A and B but not C; A and C but not B; B and C but not A; and A and B and C.

In places where the description above refers to specific implementations of applicator devices and related methods, one or more or many modifications may be made without departing from the spirit and scope thereof. Details of any specific implementation/embodiment described herein may, wherever possible, be applied to any other specific implementation/embodiment described herein. The appended claims are to encompass within their scope all such changes and modifications as are within the true spirit and scope of this disclosure.

Furthermore, in the claims, if a specific number of an element is intended, such will be explicitly recited, and in the absence of such explicit recitation no such limitation exists. For example, the claims may include phrases such as “at least one” and “one or more” to introduce claim elements. The use of such phrases should not be construed to imply that the introduction of any other claim element by the indefinite article “a” or “an” limits that claim to only one such element, and the same holds true for the use in the claims of definite articles.

Additionally, in places where a claim below uses the term “first” as applied to an element, this does not imply that the claim requires a second (or more) of that element—if the claim does not explicitly recite a “second” of that element, the claim does not require a “second” of that element. Furthermore, in some cases a claim may recite a “second” or “third” or “fourth” (or so on) of an element, and this does not necessarily imply that the claim requires a first (or so on) of that element—if the claim does not explicitly recite a “first” (or so on) of that element (or an element with the same name, such as “a widget” and “a second widget”), then the claim does not require a “first” (or so on) of that element.

Method steps disclosed anywhere herein, including in the claims, may be performed in any feasible/possible order. Recitation of method steps in any given order in the claims or elsewhere does not imply that the steps must be performed in that order—such claims and descriptions are intended to cover the steps performed in any order except any orders which are technically impossible or not feasible. However, in some implementations method steps may be performed in the order(s) in which the steps are presented herein, including any order(s) presented in the claims.

What is claimed is:

1. An applicator device, comprising:
a back panel;
one of:
a pole attached to the back panel; and
a coupler coupled with the back panel and configured for receiving a pole; and
an applicator panel having four sides each of which at least partially defines a rectangular perimeter, the applicator panel comprising a plurality of openings; and
at least one spacer coupled between the applicator panel and the back panel, the at least one spacer facilitating a gap between the applicator panel and the back panel;
wherein the applicator panel comprises a flat top surface and is configured for applying a layer of wet drywall compound to one of a wall and a ceiling.

2. The applicator device of claim 1, wherein the back panel has four sides each of which at least partially defines a rectangular perimeter.

3. The applicator device of claim 2, wherein the rectangular perimeter at least partially defined by the back panel is substantially equivalent in shape and size to the rectangular perimeter at least partially defined by the applicator panel.

4. The applicator device of claim 1, wherein some of the plurality of openings are not fully circumscribed by the applicator panel.

5. The applicator device of claim 1, wherein some of the plurality of openings are fully circumscribed by the applicator panel.

6. The applicator device of claim 1, wherein the at least one spacer comprises a plurality of spacers, each of the plurality of spacers comprising a substantially identical height so that the gap between the applicator panel and the back panel is substantially equal proximate each spacer.

7. The applicator device of claim 1, wherein the at least one spacer is hollow, and wherein the applicator panel is coupled with the back panel using a fastener which passes through the at least one spacer.

8. The applicator device of claim 1, wherein the applicator panel is substantially black to provide visual contrast with the wet drywall compound.

9. The applicator device of claim 1, wherein the four sides of the applicator panel at least partially define a square perimeter.

10. The applicator device of claim 1, wherein the applicator device comprises the coupler coupled with the back panel, and wherein the coupler is a threaded coupler.

11. The applicator device of claim 10, wherein the back panel comprises a plurality of openings, and wherein the threaded coupler is coupled with the back panel using fasteners that pass through the openings.

12. The applicator device of claim 11, wherein the fasteners that pass through the openings comprise threaded fasteners.

13. The applicator device of claim 10, wherein the applicator device comprises the pole, and wherein the pole is a threaded pole configured for attaching to the threaded coupler.

14. The applicator device of claim 1, wherein the back panel is formed of one of a metal and a polymer, and wherein the applicator panel is formed of one of a metal and a polymer.

15. An applicator device, comprising:
a back panel;
one of:
a pole attached to the back panel; and
a coupler coupled with the back panel and configured for receiving a pole;
an applicator panel comprising a plurality of openings; and
a plurality of spacers coupled between the applicator panel and the back panel, the spacers facilitating a gap between the applicator panel and the back panel;
wherein at least one of the spacers is hollow, and wherein the applicator panel is coupled with the back panel using a threaded fastener which passes through the hollow spacer; and
wherein the applicator panel comprises a flat top surface and is configured for applying a layer of wet drywall compound to one of a wall and a ceiling.

16. The applicator device of claim 15, wherein the applicator panel has four sides each of which at least partially defines a rectangular perimeter.

17. The applicator device of claim 15, wherein each of the spacers is hollow, and wherein the applicator panel is coupled with the back panel using a plurality of threaded fasteners passing through the spacers.

18. An applicator device, comprising:
a back panel having four sides each of which at least partially defines a first rectangular perimeter;
a threaded coupler coupled with the back panel and configured for receiving a threaded pole;
an applicator panel having four sides each of which at least partially defines a second rectangular perimeter, the applicator panel comprising a plurality of openings;
a plurality of spacers coupled between the applicator panel and the back panel, each of the spacers having a substantially identical height, the spacers facilitating a gap between the applicator panel and the back panel, wherein each of the spacers is hollow; and
a plurality of threaded fasteners, each threaded fastener coupling the applicator panel with the back panel through one of the spacers;
wherein the applicator panel comprises a flat top surface and is configured for applying a layer of wet drywall compound, in a repeating pattern, to one of a wall and a ceiling.

19. The applicator device of claim 18, wherein the first rectangular perimeter is substantially equivalent in shape and size to the second rectangular perimeter.

20. The applicator device of claim 19, wherein some of the plurality of openings are not fully circumscribed by the applicator panel, wherein the first rectangular perimeter comprises a square, and wherein the second rectangular perimeter comprises a square.
